(19) United States
(12) Patent Application Publication
(10) Pub. No.: US 2017/0223069 A1
(43) Pub. Date: Aug. 3, 2017

(54) Meetings Conducted Via A Network

(71) Applicant: Microsoft Technology Licensing, LLC, Redmond, WA (US)

(72) Inventors: Manish B. Arora, Hyderabad (IN); Deep Chandra Sharma, Redmond, WA (US)

(21) Appl. No.: 15/012,475

(22) Filed: Feb. 1, 2016

(51) Int. Cl. H04L 29/06; G06F 3/0482; H04L 12/58; G06F 3/0481; G06F 3/0486

(52) U.S. Cl. CPC H04L 65/403; G06F 3/04817; G06F 3/0486; H04L 51/046; G06F 3/0482

(57) ABSTRACT

A method comprising: conducting a meeting via a computer network between a plurality of user terminals each used by at least one respective user, wherein the meeting comprises each of a plurality of the users transmitting one or more respective messages from the respective user terminal to the others of the user terminals, with each of the messages being displayed as text on each of the user terminals; enabling at least one of the users to mark portions of the text to be minuted, this marking being performed through a respective user interface of the respective user terminal; and automatically generating meeting minutes from the marked portions.

### BACKGROUND

Various technologies exist which enable users to conduct communication sessions over a computer network, including between groups of three or more users. Typically the network in question is the Internet, but it could also be another type of network such as a company intranet. Such technologies include more conventional types such as instant messaging (IM), voice calls such as voice-over Internet Protocol (VoIP) calls, and video calls. Furthermore, nowadays other, more exotic types of “collaboration” technologies are also available such as screen sharing sessions, remote slide presentations, and electronic or virtual whiteboard sessions (where the user draws on a board or on screen, respectively, and the user's drawings are shared with the other users in the session).

Traditionally communication technologies such as IM, VoIP and Internet video calls were used primarily for social purposes, such as to make phone calls to distant relatives, or to arrange social engagements, or simply to exchange gossip and chit chat. Nowadays however, these technologies are also being used more-and-more to conduct meetings in a business, industrial or academic setting. For instance, a service combining two or more of voice calling, video calling, IM, screen sharing, remote slide presentations and/or a remote white board application may be used to conduct collaborative projects, such as to enable a group of engineers to collaborate on developing a new product or a new version of an existing product.

Such tools are useful because the participating users do not all have to be physically present in the same room or even at the same geographic site. For instance, increasingly there is a trend for people from two or more different countries to collaborate together on developing a new product, release, theory, discovery, or the like. Thus by means of computer-implemented communications, the geographic boundaries to collaboration are substantially broken down.

### SUMMARY

However, in practice when people in different or even the same geographies get together in a computer-implemented meeting, there tend to be a lot of issues, thoughts, and/or complexities that need to be discussed. When the organizer or indeed anyone from the meeting prepares the minutes of meeting, around 30-40% of the agenda or items are missed out from long duration meetings. There are often also disagreements as to the accuracy of minuted items. To overcome the problems associated with such human behaviours, it would be desirable to provide means to assist in the compilation of meeting minutes in order to reduce the occurrence of errors (whether errors of inaccuracy or omission). Accordingly, the present disclosure provides a mechanism to directly generate the minutes of meeting from the application (e.g. collaboration tool) used to conduct the meeting.

According to one aspect disclosed herein, there is provided a method comprising conducting a meeting via a computer network between a plurality of user terminals each used by at least one respective user, wherein the meeting comprises each of a plurality of the users transmitting one or more respective messages from the respective user terminal to the others of the user terminals, with each of the messages being displayed as text on each of the user terminals. The method further comprises enabling at least one of the users to mark portions of the text to be minuted, this marking being performed through a respective user interface of the respective user terminal. Meeting minutes are then automatically generated from the marked portions.

In embodiments the marking is indicated to each of the users through their respective user terminals during the meeting, for review before the generation of the minutes.

In embodiments, the generating of the meeting minutes further comprises automatically inserting the minutes into an email, for distribution to some or all of the users who were participants of the meeting.

Note: where it is said the meeting minutes are generated automatically, this means the operations involved in the generation are performed automatically (extracting the minuted portions from the meeting and compiling the minute document, e.g. email, from these portions). The recitation of automatically generating minutes does not necessarily mean the generation is triggered automatically (though that is one possibility, e.g. being generated automatically at the end of the meeting). Rather, in embodiments the generation may be triggered manually by a user (but then the user doesn't have to do anything else such as manually type or cut and paste items from the meeting session into the minutes). For instance, in embodiments the generating of the minutes is triggered by a single actuation of a single user interface control, e.g. a single click or touch of a single button.

According to another aspect disclosed herein, there is provided a computer program product embodied on computer readable storage (comprising one or more storage media implemented in one or more memory units), the program being configured so as when run on a processing apparatus (comprising one or more processing units) to perform operations in accordance with any of the method features disclosed herein. The processing apparatus upon which the program is designed to run could be that of a user terminal, or a server (comprising one or more server units at one or more geographical sites), or could be distributed between the user terminal and the server.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

To assist understanding of the present disclosure and to show how embodiments may be put into effect, reference is made by way of example to the accompanying drawings in which:

FIG. 1 is a schematic illustration of a communication system,

FIG. 2 is a schematic representation of a client application user interface (UI),

FIG. 3 is another schematic representation of a client application UI,

FIG. 4 is another schematic representation of a client application UI,

FIG. 5 is another schematic representation of a client application UI,

FIG. 6 is another schematic representation of a client application UI,

FIG. 7 is another schematic representation of a client application UI,

FIG. 8 is another schematic representation of a client application UI,

FIG. 9 is a schematic representation of a project dashboard, and

FIG. 10 is a schematic representation of an email.

### DETAILED DESCRIPTION OF PREFERRED EMBODIMENTS

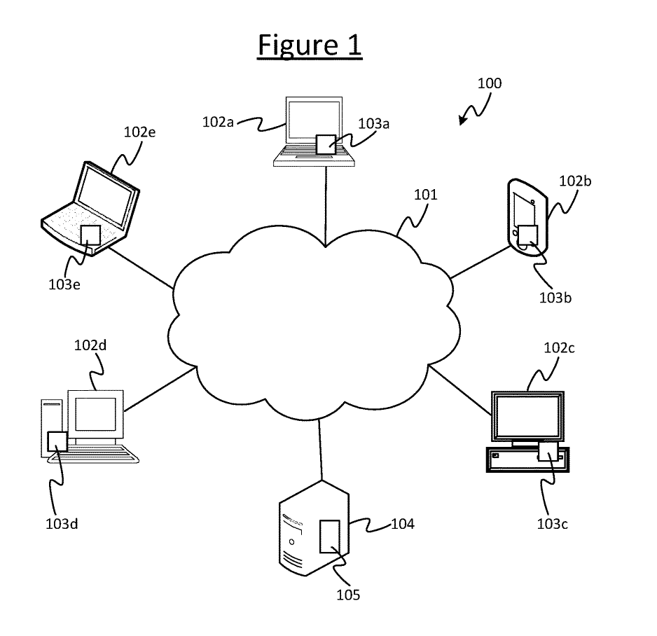

FIG. 1 schematically illustrates a communication system 100 in accordance with embodiments disclosed herein. The communication system comprises a plurality of user terminals 102 each configured to connect to a computer network 101, and each installed with a respective instance of a communication client application 103. In FIG. 1, five user terminals 102a-e and their respective clients 103a-e are shown for illustrative purposes, but it will be appreciated that there may be different numbers of user terminals 102 involved in other scenarios covered by the present disclosure. The network 101 is preferably a packet-based network. In embodiments it may take the form of a wide-area internetwork such as that commonly referred to as the Internet. Alternatively the network 101 may take the form of another type of network such as a company intranet, a mobile cellular network, or a wireless local area network (WLAN), or a combination of any of these and/or the Internet.

Each of the user terminals may take any of a variety of different forms, such as a desktop computer, laptop, tablet, smartphone, smart watch, pair of smart glasses, smart TV, set-top box, or conference room phone unit (and the different user terminals 102 need not necessarily take the same form as one another). Note therefore that the term “computer” as used herein does not restrict to a traditional desktop or laptop computer.

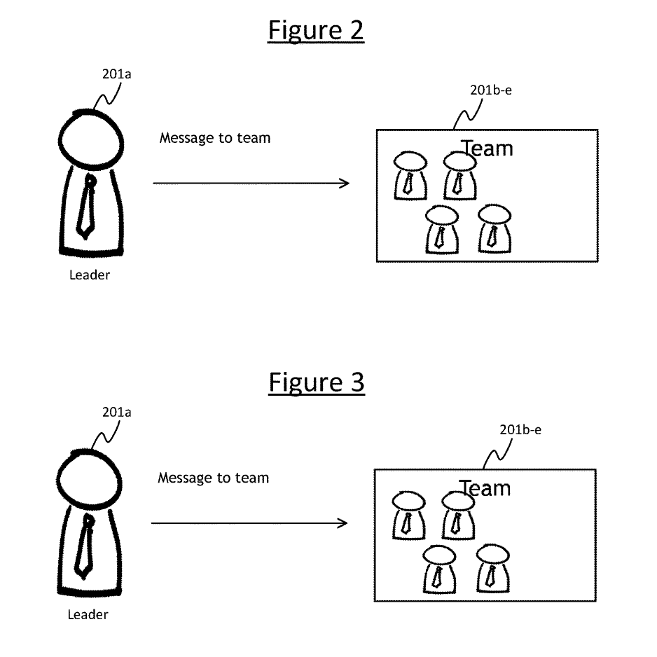

Each of the user terminals 102 is also used by at least one respective user 201. These users 201a are illustrated in FIGS. 2 to 5 by way of example. The examples of FIGS. 2 to 5 will be returned to in more detail shortly. Note that for illustrative purposes only one user 201a-e is shown per user terminal 201a-e, respectively, but it will be appreciated this is not limiting. For example, at least one of the terminals may comprise a conference room phone unit or shared laptop, e.g. placed on a conference room table, around which two or more users are gathered in the same room (and the user terminal optionally also comprises a separate screen placed or mounted somewhere in the room where all the respective users can see, and/or an electronic whiteboard placed or mounted somewhere in the room where one, some or all the respective users can use it). Note that for the present purposes, any I/O peripherals such as external screens, whiteboards, microphones and/or headsets are considered part of the respective user terminal.

The communication clients 103 are each installed on computer-readable storage of their respective user terminal 102, and arranged for execution on a respective processing apparatus of the respective user terminal 102. The storage may take the form of one or more storage media (e.g. magnetic memory, electronic memory or optical memory) implemented in one or more memory units. The processing apparatus may take the form of one or more processing units. Each of the communications clients 103 is configured so as to be able to establish a communication session with one or more others of the communication clients 103 running on one or more of the other respective user terminals 102. The user of each user terminal 102 is then able to send messages to each other of the users of each other of the user terminals 102 participating in the session. In embodiments, the messages may include any one or more “traditional” types of message such as: IM messages, voice (e.g. VoIP) streams (of the sending user's voice), and/or video streams (e.g. a head-and-shoulders shot of the sending user). Alternatively or additionally, the messages may include one or more graphical messages such as: screen sharing streams, remote slide representations, and/or electronic or virtual whiteboard streams. In one particular application of the techniques disclosed herein, the client 103 application takes the form of a collaboration tool such as a project management tool, which combines the functionality of IM, video calling with the sharing of graphical content such as one, more or all of: screen sharing, remote slide presentation, sharing content from an electronic whiteboard, and/or sharing content from a virtual whiteboard (shared drawing functionality implemented through the screens of one or more desktop computers, laptop computers, tablets and/or smartphones).

As mentioned, there may be any number of user terminals 102 and hence users 201 involved in the session. Nonetheless, in a particular application of the techniques disclosed herein, the communication session in question is a combined session between three or more users 201, and/or between three or more user terminals 102. That is, when the user 201a of one user terminal 102a sends a message to the session, the message is automatically delivered to each of the other user terminals 102b-e (the user 201a does not have to create separate sessions nor manually address the message to each of the separate users 201b-e or user terminals 102b-e).

In embodiments the communication system 101 comprises a server 104 connected to the network 101, arranged to provide a communication service via which the communication session is at least in part conducted. In such embodiments, the message from any given one of the users is sent from the sending user terminal, e.g. 102a, to the server 104, and the server 104 is configured to forward the message on to each of the recipient user terminals 102b-e. Alternatively however, the messages may be sent based on a peer-to-peer (P2P) topology, in which case the server 104 is not needed for the purpose of forwarding the messages to their destination.

Note also, in yet further embodiments, the system need not comprise a communication client 103 installed on each user terminal 102. For instance, alternatively one, some or all of the user terminals could instead be installed with a general purpose web browser operable to access a web-based version of the client application (“web client”) hosted on the server 104. In such cases the described functionality may be achieved by the web-client rather than the locally installed client (i.e. client installed locally on an individual user terminal 102). Or more generally, the functionality disclosed herein can be implemented in any combination of local (on each user terminal 102) and/or server hosted functionality. Embodiments disclosed herein may be described in relation to a local client 103 by way of illustration, but it will be appreciated that this is not limiting.

Regardless of whether the messages are sent via the server 104 or whether they are sent peer-to-peer, and regardless of whether a local clients is installed on each user terminal 102 or whether a server-hosted client is used, in embodiments the server 104 may also be arranged to provide additional functionality in association with the communication service. For instance, the server 104 may maintain a contact a list of user profiles 105, each profile comprising information on a respective one of the users, e.g. 201a, made available from the server 104 via the network 101 to the others of the users 201b-e in the session. In embodiments, the profiles may also be made available to any other users of the service whom the user in question has accepted as a contact. The information in each user's profile may comprise for example any one or more of: an email address of the respective user, a profile picture of the respective user, a mood message of the respective user, a place of residence of the respective user, and/or a time zone or local time of the respective user, etc. As will be discussed shortly, in particular embodiments the profile information 105 comprises at least an email address of each user.

By means of the communication system described in relation to FIG. 1, or the like, the users are able to conduct communication sessions between one another via the network 101. Such sessions can be used to conduct meetings, which may for example be of a professional, commercial, industrial, business, engineering, or academic nature, or the like. The communication system enables users to collaborate on projects, such as to develop a new product, despite not all being physically present in the same room or at the same geographic site, or in many cases without even all being in the same country.

However, as identified herein, there remains scope to augment such systems in at least one other respect—that is, to record of the key points arising during the meeting in a more accurate and/or representative manner.

By way of comparison, FIGS. 2 to 5 illustrate an example scenario that may occur without the techniques of the present disclosure.

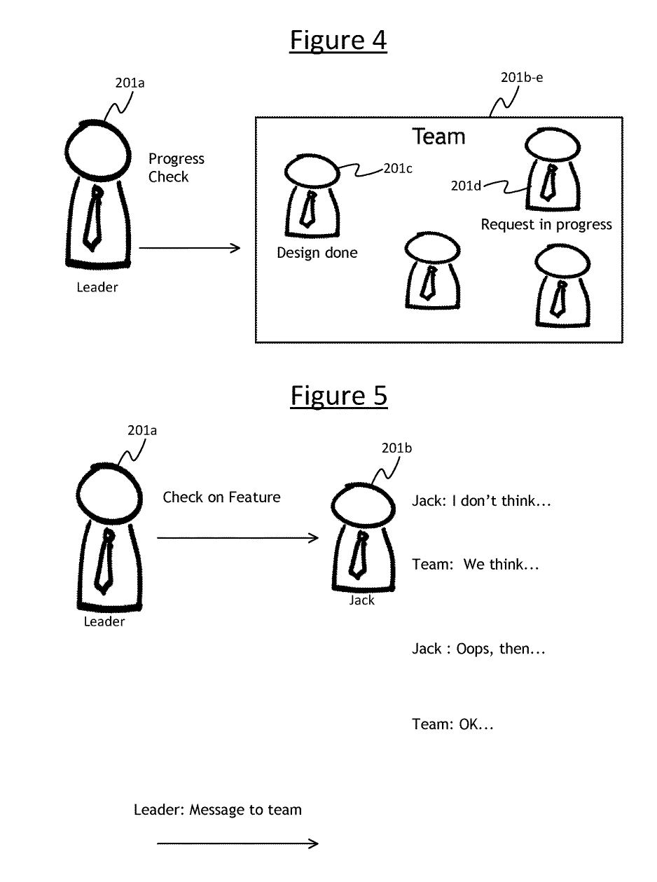

In FIGS. 2 to 5 a first user 201a (Dave User) is leading a meeting, while the other participating users 201b-e are his team. This status as leader could be a parameter of the session (e.g. registered in the server 104 and displayed to the users 201 via the clients 103 running on their user terminals 102), or instead it could simply be a role understood mentally by the users 201. Either way, in FIG. 2 the leader 201a announces to his team 201b-e that they are having a meeting to start a certain project N. For example the project could be to develop a new product or new version of a product. In FIG. 3 the leader 201a explains that the purpose of the first meeting is to set out a roadmap for the project, which (perhaps amongst other things) will set certain actions for different specific members of the team 201b-e. Then, on a later occasion as shown in FIG. 4, the leader 201a holds another meeting to review the progress of the action items set by the first meeting. He learns that one of the users Sally 201c has successfully completed her action (e.g. a design), and that another of the users Colin 201d has begun his action but it is still in progress. However, as shown in FIG. 4, another of the users Jack 201b has completely forgotten his action! (E.g. this could have been to review a certain feature or potential feature X of the product being developed). No-one in the meeting can agree whether this action was in fact decided upon or even discussed during the meeting, because the topic did not make it into the minutes of the meeting (which were manually written by one of the participants, e.g. the leader Dave 201a or one of the other participants Jane 201e). As a result, the team notes that the project is going to eat up more time, so the product will now take longer to come to fruition.

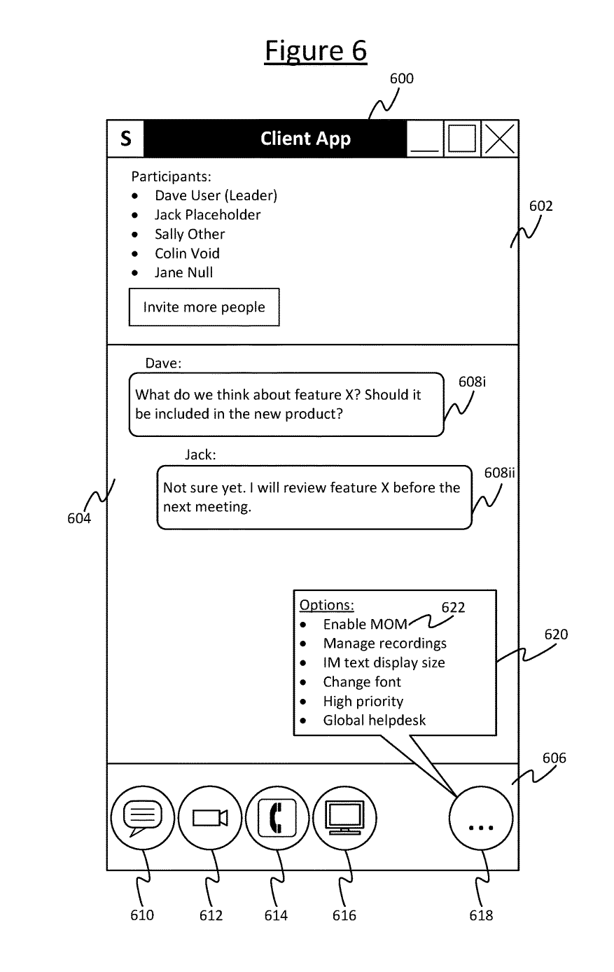

Such errors are an inherent result of unreliable human behaviours. It would be desirable to overcome such human behaviours in order to more accurately generate a representative record of the content of a communication session. Accordingly, the present disclosure provides a mechanism for automating the taking of meeting minutes. Some examples are discussed in relation to FIGS. 6 to 10.

FIG. 6 shows an example front-end 600 of a communication client 103 in accordance with embodiments disclosed herein. This may represent the front-end user interface (UI) of each of any one, more or all of the communication clients 103 discussed above in relation to FIG. 3, and the following functionality may be included in any one, more or of the clients 103 (or the web-clients or other server-hosted clients). For illustrative purposes, the following will be described from a perspective a particular one of the use terminals 102a, but it will be appreciated that similar functionality can be implemented by the client applications 103 running on any one, more or all of the other user terminals 102b-e.

The graphical front-end 600 of the user interface is implemented through a user interface device if the respective use terminal 102, e.g. a touch screen, or a screen and pointing device (e.g. mouse or trackpad) plus a point-and-click user interface mechanism. In general the term “user interface” can refer to either or both of a user interface device (no shown) or graphical front-end 600, but as a short-hand in the rest of this description the graphical front-end 600 shall be referred to as the user interface.

The user interface 600 comprises a participants section 602 which lists the participants of the meeting, a message section 604 in which the actual messages of the meeting are displayed, and a control section 606. The messages 608 in the message section are displayed as text. They may comprise one or more messages that originated from the sending terminal (e.g. 102b), such as IM messages. Alternatively or additionally, the messages in the message section may comprise messages that originated from the sending user terminal (e.g. 102b) in the form of another media but which are converted to text for display in the user interface 600. For instance, the message may have originated as a voice stream of a voice call, but be translated to text by a speech recognition algorithm. As another example, the message may have originated as a graphical messages (e.g. a video stream of a video call, a slide of a remote presentation, or a drawing from an electronic or virtual whiteboard) but may be converted to text by a text recognition algorithm. The voice or text recognition algorithm may be implemented on the server 104, or in the individual client 103a at the receive side, or in the individual client at the send side 103b (and so the conversion may be performed at any of these places).

The control section 606 comprises a number of on-screen controls that can be actuated by the user 201a of the respective user terminal 102a (the “local” user). E.g. each of the controls may be a respective on-screen buttons that can be touched through a touch screen or clicked through a point-and-click interface. These controls may include: an IM control 610 for selecting to access instant messaging as part of the meeting session (to send and/or receive IMs), a video call control 612 for selecting to access video calling as part of the meeting session (to send an outgoing video stream and/or receive an incoming video stream), a voice call button for selecting to access voice calling (e.g. VoIP) as part of the meeting session (to send an outgoing voice stream and/or receive an incoming voice stream), and a screen-sharing button 616 for selecting to access screen sharing as part of the session (to share the screen of the local user terminal 102 with the other user terminals 102b-e or to view the screen shared by one of the other user terminals 102b-e). The controls may also include an options control 618 enabling the local user 201a to summon a menu of options (e.g. settings) 620, such as “Manage recordings”, [change] “IM text display size”, “Change font”, [set outgoing messages to] “High priority”, and [access the] “Global helpdesk”.

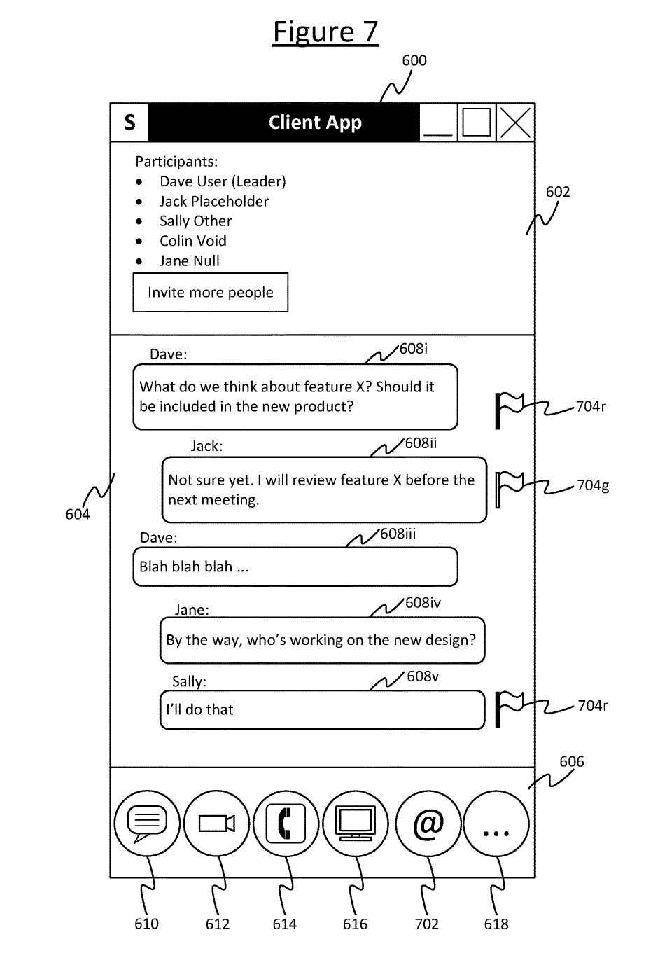

In embodiments, the options 620 comprise an option 622 to enable a MOM (minutes of meeting) feature. In FIG. 6 this is shown as being part of the options menu 620 with the control 618 to summon options menu 620 being placed in the lower right of the client UI 600. However, more generally E.g. this control 622 can be placed anywhere in the UI 600, e.g. anywhere in the meeting or chat window. When the local user 201a selects this option 622 (e.g. touches or clicks it from the menu), this activates the ability of the local client 103a to record minute items as part of the communication session through which the meeting is being conducted. As shown in FIG. 7, selecting the enable-MOM option 622 may cause a generate-minutes control 702 to be displayed in the user interface 600, wherein the generate-minutes control 702 can be actuated by the local user 201a. For example, this control 702 may comprise an on-screen button that can be touched via a touch screen of the user terminal 102a or clicked via a point-and-click mechanism. Note that it is not necessary in all possible embodiments for the generate-minutes control 702 to be summoned via an enable-MOM option, and instead the generate-minutes control 702 may be a permanent feature of the user interface 600, or may be summoned by other means or in response to one or more other factors. Further, it is not necessary in all possible embodiments to include a setting 622 for enabling the client 103a to take minutes, and instead this feature may simply be permanently enabled, or may be enabled by other means or in response to one or more other factors. E.g. the client 103a may be configured to recognise the word “minutes” (or variants thereof) or a specific take-minutes command in the text of one of the messages 608, and enable the minute-taking feature in response to this.

When the minute-taking feature is enabled (if indeed it needs enabling), the client application 103a is configured to provide a mechanism by which the local user 201a can mark portions of the text as items to be minuted. This may comprise marking individual whole messages 608 (i.e. on a per message basis), and/or marking a portion of text within a given message 608, and/or marking a portion of text spanning multiple of the messages 608.

FIG. 7 illustrates one mechanism by which the local user 201a can mark portions of the text to be minuted. Here, the user is enabled to mark said portions by clicking or touching the text or an area of the screen associated with the text. For instance, the user 201a can select a particular message 608, or a point on the screen next to the message 608. The client 103 then allocates the status of a minuted item to the message in question. In embodiments, the marking may be indicated by means of a flag 704 placed on screen next to the minute message or text. In a variant of the mechanism shown in FIG. 7, the user 210a is enabled to mark the portions of text to be mined by dragging-and-dropping an icon onto the text or an area of the screen associated with the text, e.g. a flag icon.

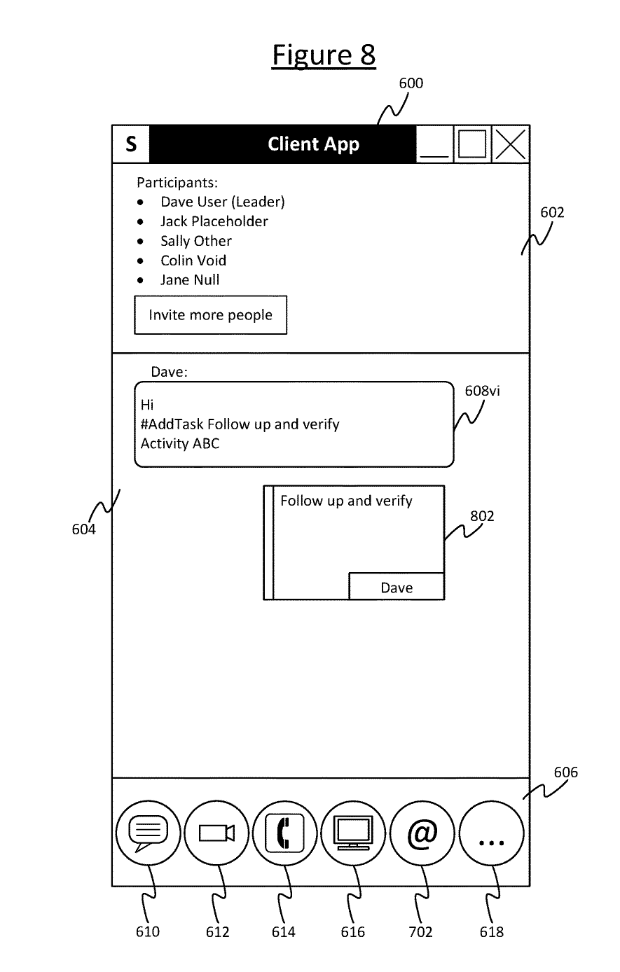

FIG. 8 illustrates another alternative or additional mechanism by which the local user 201a can mark portions of the text to be minuted. Here, the user 201a is enabled to mark said portions by tagging with at least one predetermined non-alphanumeric character included in the same message as the text (e.g. in an IM message). For example this non-alphanumeric character may be # (hash). In embodiments the message may be marked in response to recognizing a particular command in the message tagged by the hash (or other such non-alphanumeric character), e.g. #Minute, #AddTask, #Action, #Comments, and/or #Minute (and such tags may or may not be case sensitive). Such tags are sometimes referred to as “hash tags”. The at least one non-alphanumeric character acts as an escape character or escape sequence, telling the client 103a that this is not intended as message content (or not only as message content), but rather a command to the minuting function of the client 103a. In embodiments, the hastag (or the like) may cause a flag to be displayed in association with the tagged message or text as shown in FIG. 7, and/or may cause a preview of a minutes entry 802 to be displayed in the message window 604 as shown in FIG. 8.

In embodiments, the client 103a may enable the user 201a to mark the minuted portions as action items associated with a particular identified one of the users. This mean a user ID of a target user is assigned to the minute item, such as an email address of the target user, or a username of the user within the communication system, or a given name of the target user. For instance, the user 201a setting the action item may be provided with the ability to right click on a flag and then be presented with an option to select one of the participating users from the list (whether that be him or herself 201a, or one of the other users 201b-e). As another example, the hastags (or other such command based on a non-alphanumeric escape character or sequence) may be used to specify the ID of the target user for the action. E.g. the user 201a may send an IM message: “Need to have LCA approval for Project N. #MainSubject:MOMItem1 #Action:ColinVoid@example.com”

Alternatively or additionally, the client 103a may be configured to enable the user 201a to annotate the minuted portions with comments. For instance, the user 201a adding the comment may be provided with the ability to right click on a flag and then be presented with a text box in which to type the comment. As another example, the hastags (or other such command based on a non-alphanumeric escape character or sequence) may be used to specify the ID of the target user for the action. E.g. The user 201a may send an IM message: “LCA Approval is required for this project to go live as there are many regional compliance needs to be followed. #Comment:‘Colin is on holiday until 4 Jan’”.

In further alternative or additional embodiments, the client 103a is configured to enable the user 201a to mark the minuted portions as items and sub-items in a tree structure. E.g. this could be done by clicking the message (or area next to the message) multiple times to cycle through different hierarchical levels of flag, or by dragging and dropping a particular one of multiple available flag types onto the message. Alternatively or additionally, the different hierarchical levels of minute item can be created through different hashtags (or other such commands based on non-alphanumeric escape characters or sequences). E.g. a tag such as #MainSubject or #Mainitem may be used to mark first hierarchical level, whilst another tag such as #Comment or #SubItem may be used to flag a second, subordinate hierarchical level. These tags may again cause different types of flag to be displayed in association with the respective tagged messages or other such portions of flagged text.

For instance, in embodiments a flag of a first colour such as a red flag 704r may mark main items for the minutes of the meeting, whilst a flag of a second colour such as a green flag 704g may mark discussion or comment items linked to a main item in the minutes of the meeting.

When it is time to produce the minutes (e.g. at the end of the meeting), the user 201a actuates the generate-minutes UI control 702. In response, the client application 103a or server 104, or a combination of the two, automatically generates the minutes from the marked items in the meeting history. That is, after instigating the generation of the minutes via the UI control 702, the user 201a (nor any user) does not have to do anything further to produce the minutes, such as typing up the minutes or cutting-and-pasting passages from the meeting history. In embodiments, the minutes are generated in response to a single actuation of the generate-minutes UI control 702, e.g. a single click or touch of a single button, or a single unbroken gesture if the UI is gesture controlled.

Alternatively, the triggering of the minutes-generation could even be automated. In this case, the client 103a and/or server 104 is configured to automatically detect when the meeting is over, e.g. when all the users have left the session, or when all but one of the users have left the meeting, or when an end-meeting UI control (not shown) has been actuated by the leader (or possibly another user); and in response to such a detection, to automatically generate the minutes.

Either way, the automated generating of minutes may comprise inserting the marked text (e.g. messages 608i, 6908ii and 608v in the example of FIG. 7) verbatim into the minutes. Alternatively, the automated generating of minutes may comprise processing the marked text, e.g. using natural language processing techniques to recognize key concepts and to include these as condensed versions of the marked text in the minutes. Either way, the automated generating of minutes may comprise further processing of the user-defined markings, e.g.: (i) automatically including the user-defined action items so as to indicate the identified target users for those actions in the minutes, and/or (ii) automatically including the comments associated with minuted items in the corresponding places in the minutes, and/or (iii) automatically structuring the meeting minutes so as to reflect the user-defined tree structure (hierarchy) of the minuted items.

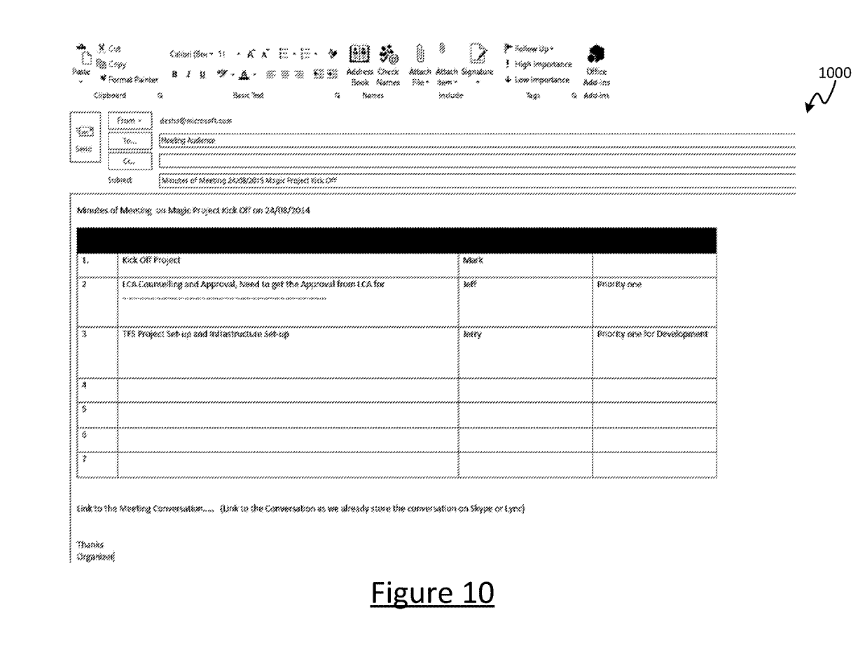

In embodiments, the generating of the minutes comprises generating a minute document, e.g. inserting the minutes into an email 1000. An example of this is shown in FIG. 10.

Automatically generating an email containing the minutes is a useful way to prepare the minutes for distribution. In some embodiments, this may be further facilitated by automatically including email addresses of the users as recipients of the email, wherein the email addresses are automatically retrieved from profiles 105 of the users, being profiles maintained in relation to a communication service used to conduct said meeting (e.g. the profile information being stored at and retrieved from the server 104). Thus an email containing the minutes and being populated with the email addresses of the participants is automatically produced at the press of a button 702, or such like, and now all the user 201a has to do is press send. In variants of this, the email may even be sent automatically in response to only the generate-minutes 702 control, or the email may even be generated and sent completely automatically when the client 103a and/or server 104 detects the end of the meeting (see above). In other variants, the user 201a may generate the email containing the minutes, but prompt the user to select from a list which other users 201b-201e to include in the emails destination field(s), or simply to require (or allow) the user 201a to enter the destination email addresses manually.

The email option can be limited to the organizer 201a or the control can be passed on. In embodiments this option will link the email box configured on the sending user terminal 102a or server 104 and will open an email with the “To” field containing all the participants or the audience to which the meeting was set-up for. The content selected will be included in the email with all the action items and the listed portions of discussions and decisions. A certain template design can also be a part of the client application 103a or commination service provided by the server 104, for any organization to share the minutes in any specific Format.

FIG. 10 shows an example email 1000 generated from a template in accordance with embodiments herein. The email template is ready to be shared from the organizer's (leader's) email and if needed or desired can be modified accordingly to add or modify the content.

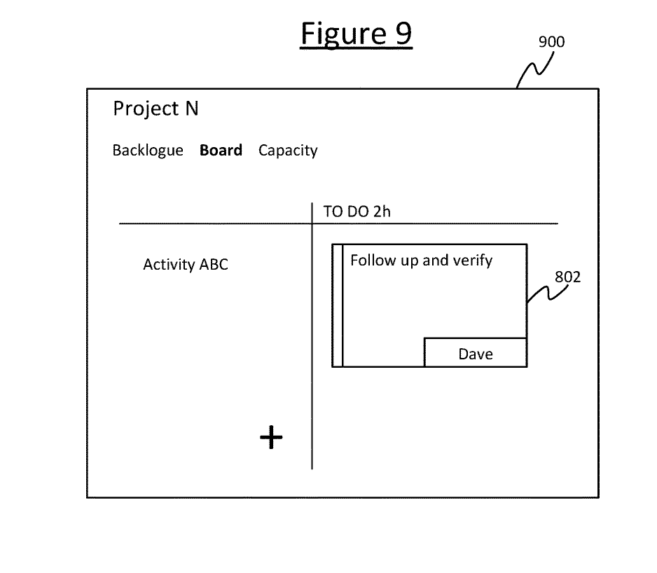

As an alternative or in addition to generating the email 1000, as shown in FIG. 9, the generating of the minutes may comprise automatically inserting the minutes into a project dashboard 900 (a graphical front-end for managing a project). In embodiments, the project management dashboard 900 is an online tool which one, some or all of the other participants 201b-e of the meeting also have access. The project management dashboard tool 900 may be a pre-existing product itself already available in the market, to which the meeting minutes automation feature is linked; or alternatively the project management dashboard 900 may be a designed specially to accompany the meeting minutes feature. The minutes may be automatically uploaded to the dashboard 900 when the meeting is over, or when the user 201a actuates the generate-meeting control 702 (perhaps subject to a further review and approval step to trigger this). Thus there is provided another way to distribute the minutes to the other participants 201b-e. For example, one, some or all of the minute items may be added as tasks for specified team members.

FIG. 9 shows the output of the statement in one of the “hashtag” type embodiments discussed above, where a user types “#AddTask . . . ” to assign a task to particular person.

More generally, the generated minutes can be distributed to any one, some or all of the other users 102b-e by any means, via the network 101 or otherwise, e.g. by uploading the minutes document to any shared storage location, uploading the minutes to any shared tool, or by sending the minutes document to any shared communication channel (e.g. web forum, or even within the same communication session that is used to conduct the meeting), or by any other means. The generation and distribution may be completely automatic upon detecting the end of the meeting, or the distribution may be automatically triggered by the same user control 702 that causes the minuted to be generated, or the distribution may be triggered by actuation of a further user control (e.g. following a review of the automatically generated minutes by the sending user such as the leader 201a or a user assigned the role of rapporteur). In embodiments, the client application 103a and/or server 104 may be configured to enable the sending user (who instigated the minutes) to review the minutes before sending, and edit them if required or desired.

Note: the above has been described from the perspective of the local user 201a of the user terminal 102a and client 103a performing the marking. However, the marking of the portions of text as minuted is also indicated to each of the users, over the network 101, through the user interfaces of their respective clients 103b-e running on their respective terminals 102b-e. This enables the other users 201a-e to review the minuting before the generation of the meeting minutes. E.g. another user 201e could send a message to object or point out an error or suggested amendment.

Further, in embodiments one, some or all of the other, remote users 102a may also be able to mark text as minuted and/or to generate the minutes, in a similar manner as described above, but though their own respective client application 103b-e running on their own terminal 102b-e (or through a web client). Again the marking of minute items may be done either on a per message basis, or by marking a sub-portion within a message, or marking a portion of text spanning more than one message). Such minutings will also be shown to the first user 201a in a reciprocal manner to the way the first user's minutings are shown to the other users. In embodiments, similar functionality may apply from the perspective of any user 201a-e in the session.

Alternatively, in embodiments, only one or a subset of the users having a predefined permission status to mark minute items. E.g. this could be only the leader 201a, or only a user having a special status such as rapporteur, or only a subset if the users (e.g. 201a-c) who have a special status as, say, curator, administrator, moderator or rapporteur. The status may be recorded in the server 104 at least for the duration of the session. In embodiments, the leader 201a may be given the power to allocate permission statuses, e.g. to allocate the rapporteur role to another of the users 201e.

It will be appreciated that the above embodiments have been described only by way of example.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals and/or server may also include an entity (e.g. software) that causes hardware of the user terminals to perform operations, e.g., processors functional blocks, and so on. For example, the user terminals and/or server may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals and/or server through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
conducting a meeting via a computer network between a plurality of user terminals each used by at least one respective user, wherein the meeting comprises each of a plurality of the users transmitting one or more respective messages from the respective user terminal to the others of the user terminals, with each of the messages being displayed as text on each of the user terminals;
enabling at least one of the users to mark portions of the text to be minuted, said marking being performed through a respective user interface of the respective user terminal; and
automatically generating meeting minutes from the marked portions.

2. The method of claim 1, wherein said generating of the minutes is triggered by single actuation of a single user interface control.

3. The method of claim 2, wherein said user interface control comprises a single on-screen button, and said actuation comprises a single press or touch of the button.

4. The method of claim 1, wherein the generating of the minutes comprises automatically inserting the minutes into an email for sending to some or all of the users.

5. The method of claim 4, wherein said generating comprises automatically including email addresses of the users as recipients of the email, wherein the email addresses are automatically retrieved from profiles of the users, being profiles maintained in relation to a communication service used to conduct said meeting.

6. The method of claim 1, wherein the generating of the minutes comprises automatically inserting the minutes into a project management dashboard.

7. The method of claim 1, wherein the marking of said portions is indicated to each of the users via their respective user interfaces for review before the generation of the meeting minutes.

8. The method of claim 1, wherein the at least one user is enabled to mark said portions by clicking or touching the text or an area of the screen associated with the text, or by dragging-and-dropping an icon onto the text or an area of the screen associated with the text.

9. The method of claim 1, wherein the at least one user is enabled to mark said portions by tagging with at least one non-alphanumeric character included in the same message as the text.

10. The method of claim 9, wherein said non-alphanumeric character is #.

11. The method of claim 1, further comprising enabling the user to mark the minuted portions as action items associated with a particular identified one of the users, wherein the generating of the meeting minutes comprises automatically including the action items indicating the identified users in the minutes.

12. The method of claim 1, further comprising enabling the at least one user to annotate the minuted portions with comments, wherein the generating of the meeting minutes comprises automatically including the comments in the minutes.

13. The method of claim 1, further comprising enabling the at least one user to mark the minuted portions as items and sub-items in a tree structure, and the generating of said minutes comprises automatically reflecting the tree structure in the meeting minutes.

14. The method of claim 1, wherein said at least one user comprises all of the users.

15. The method of claim 1, wherein said at least one user comprises only one or a subset of the users having a predefined permission status.

16. The method of claim 1, wherein said messages comprise one or more of:
IM messages;
voice communications, which are transcribed for the display on the user terminals and for the marking of said portions; and/or
graphical messages, from which the text is recognized by a text recognition algorithm for display on the user terminals and for the marking of said portions.

17. The method of claim 1, wherein said network is the Internet.

18. A computer-program product embodied on computer-readable storage and configured so as when executed on one or more processing units to perform operations of:
conducting a meeting via a computer network between a plurality of user terminals each used by at least one respective user, wherein the meeting comprises each of a plurality of the users transmitting one or more respective messages from the respective user terminal to the others of the user terminals, with each of the messages being displayed as text on each of the user terminals;
enabling at least one of the users to mark portions of the text to be minuted, said marking being performed through a respective user interface of the respective user terminal; and
automatically generating meeting minutes from the marked portions.

19. A first user terminal comprising:
a network interface;
a user interface;
processing apparatus comprising one or more processing units; and
memory comprising one or more memory units, storing a communication client arranged to run on the processing apparatus in order to use said network interface to conduct a meeting over a computer network between the first user terminal and a plurality of other terminals, each used by at least one respective user, wherein the meeting comprises each of a plurality of the users transmitting one or more respective messages from the respective user terminal to the others of the user terminals, with each of the messages being displayed as text on each of the user terminals;
wherein the communication client application is configured to enable at least the user of the first user terminal to mark portions of the text to be minuted, said marking being performed through said user interface; and
wherein the communication client application is further configured to automatically generating meeting minutes from the marked portions.

20. The first user terminal of claim 19, wherein the generating of the minutes comprises automatically inserting the minutes into an email for sending to some or all of the users.
